(19) United States
(12) Patent Application Publication
(10) Pub. No.: US 2010/0157509 A1
(43) Pub. Date: Jun. 24, 2010

(54) High Temperature Boron Oxynitride Capacitor

(75) Inventors: Nacer Badi, Houston, TX (US); Abdelhak Bensaoula, Houston, TX (US)

Correspondence Address: BURLESON COOKE L.L.P., 2040 NORTH LOOP 336 WEST, SUITE 123, CONROE, TX, 77304, US

(73) Assignee: Integrated Micro Sensors Inc., Houston, TX (US)

(21) Appl. No.: 12/340,665

(22) Filed: Dec. 20, 2008

(51) Int. Cl. H01G 4/12; B05D 5/12

(52) U.S. Cl. 361/321.4; 427/79

(57) ABSTRACT

A method for storing energy in a capacitor includes connecting a first conductor to a first electrode and a second conductor to a second electrode. The second electrode is separated from the first electrode by a dielectric layer. The dielectric layer includes a layer of boron oxynitride, BON. The conductivity of the dielectric layer is lower than the conductivity of the first electrode or the second electrode. A voltage of at least 5 volts is applied between the first electrode and the second electrode by means of the first and second conductors.

### BACKGROUND OF THE INVENTION

1. Field of the Invention

This disclosure relates to electronic devices. In particular, a capacitor and method for storing energy at high temperature are disclosed.

2. Description of Related Art

Capacitors are critical electronic devices found in large numbers in many everyday products. For example, computers, telecommunications equipment, mobile phones, automobiles, and military equipment each make heavy use of state-of-the-art capacitors. Capacitors that are reliable and inexpensive are thus in great demand.

One conventional structure for ceramic capacitors is a structure of multiple layers in which dielectric layers of ceramic are interleaved with conductive electrodes. Every other conductive electrode is electrically connected, resulting in a device having two effective electrodes with a capacitance many times the capacitance of the single dielectric layer. Such multilayer ceramic capacitors (MLCCs) are the most reliable component for high-energy density storage banks. They also find use in high frequency switch mode power supplies, and account for a large part of the capacitor market, as discussed in T. Nomura et al, “Multilayer Ceramic Capacitors—Recent Trends,” IEEE, Ferroelectrics, 1996, p. 135. One goal of MLCCs is to achieve higher capacitance in combination with a smaller size. The realization of MLCCs with higher capacitance and volumetric efficiencies is today's biggest challenge for MLCC manufacturers. Such MLCCs could be used in application fields in which electrolytic or plastic film capacitors are currently used.

The main limiting factors for MLCC development are thickness control, the integrity of the dielectric layers and effective electrodes. The primary objectives are smaller case sizes for a given capacitance value, higher reliability and lower cost per unit. The conventional dielectrics that dominate the market are sintering-based NPO, X7R and Z5U. These materials are limited by change in capacitance as a function of temperature and a high rate of aging. Also, large grain size (>3 μm) of the oxide or perovskite powder limits the thickness of the dielectric layer.

In high C-V/Volume capacitors, use of precious metal and the high layer count increase the cost of the capacitors. One objective is to have lower cost per unit. Lack of availability of high-temperature, high-power capacitors has been one of the weak links in high temperature electronics. The three types (classes) of existing capacitors can operate properly only within the military range of temperature—up to about 300° C. Several manufacturers offer capacitors designed for operation up to these temperatures. However, as the operating temperature increases, the choices and data become progressively limited. The inventors are not aware of any commercial capacitors specified for use above 300° C.

The equations for a capacitor are:

Capacitance (C)=KA/fd (picofarads) and C/Vol∝Kd⁻²

where,
f: conversion factor
(metric system: f=11.31: cm).

The energy stored, U, is:

$$U = \frac{{CV}^{2}}{2} = \frac{1}{2} \frac{KA}{f} {d ( E )}^{2} \\ V = E \cdot d \qquad Eq . 1$$

and the energy density stored in a capacitor (potential energy/volume or mass) is:

$$Δ F = \frac{U}{{V}_{ol}} = \frac{1}{2} {KE}^{2} ( volume ) = \frac{1}{2} \frac{{KE}^{2}}{ρ} ( mass ) \qquad Eq . 2$$

where K is the relative dielectric constant of the material, A is the effective area of the internal electrode, d is the thickness of the dielectric layer, and E is the electric field. Parametrically, it is desirable to optimize K, A/d and E simultaneously. Practically, it has been easier to attack the problem from two approaches. The first of these is to engineer dielectric films with high K and E. This work extended the energy density of “conventional” capacitors by an order of magnitude, as discussed in M. F. Rose, Transactions of the IEEE on Magnetics, 22, 1986. The current trend is to optimize the A/d ratio in the expression for the capacitance. This will result in high energy density at lower voltage.

The parameters of interest for such capacitors include:

Capacitance (C).

Temperature coefficient of capacitance (TCC).

Breakdown voltage (BDV).

Capacitance per unit volume or weight (volumetric or weight efficiency).

Dissipation factor (DF) or loss tangent.

Insulation resistance (IR)

For certain applications, radiation immunity.

The development of compact and miniature power sources that operate over an extended temperature range becomes possible by replacing existing capacitors with high-temperature capacitors. This development can make possible several new heavy-duty devices in the semiconductor industry, the military (e.g., explosives, fuses, safe-arm-fire devices, and explosive detonators), and space (e.g., compact power supplies, solar-powered equipment). High-temperature capacitors are well suited for pulse power applications such as ignition systems, lasers, x-ray generation, power supplies, electric vehicles, solar-powered equipment and physics research. Applications involving compact power density sources operating in harsh environments and compatible with Micro Electro Mechanical Systems (MEMs) are also possible. Compact power density sources also find use in high frequency switch mode power supplies, because they can be optimized to minimize both effective series resistance (ESR) and effective series inductance (ESL).

A capacitor to be used in a semiconductor memory is disclosed in U.S. Pat. No. 6,144,546. A hexagonal boron nitride as a dielectric is disclosed. The capacitor of the '546 patent includes nanoscale (0.5-5 nm thick) layers of conductors or semiconductors so that two-dimensional electrical conduction occurs along the layers, thereby suppressing leakage current. The dielectric layer is also thin for the low voltage (about 2V) applications anticipated in large-scale integrated circuits.

At the macroscale geometry of such capacitor, mechanical defects (pinholes, grain boundaries) in advanced ceramics such as BN are normally present (U.S. Pat. Nos. 6,939,775 and 6,570,753). Having these mechanical defects will hinder severely the electrical properties of the device through metal diffusion into the dielectric (electrode diffusion). The single capacitor and therefore the MLCC electrodes will be shorted through huge transverse leakage currents. Furthermore, it is well known that diffusion increases with ambient temperature. In prior art capacitors, a minimum diffusion barrier thickness is required to prevent electrode diffusion into the dielectric layer. But, the required layer to serve as a diffusion barrier increases the distance between electrodes, causing a decrease in capacitance and energy density of MLCCs.

What is needed is a high-temperature capacitor that can achieve high energy density storage, can operate at relatively high voltage with low leakage current and that can be produced at a reasonable cost. In particular, high quality, pinhole-free dielectric layers are needed, preferably in layers that do not need diffusion barriers for high temperature operation.

### SUMMARY OF THE INVENTION

A capacitor and method of storing energy is disclosed. None of the advantage disclosed, by itself, is critical or necessary to the disclosure.

A method for storing energy in a capacitor is disclosed that includes connecting a first conductor to a first electrode. A second conductor is connected to a second electrode. The second electrode is separated from the first electrode by a dielectric layer. The dielectric layer includes a layer of boron oxynitride, B_{y}OₓN₁₋ₓ or B_{y}NₓO₁₋ₓ where y and x vary and are greater than 0 but can equal 1. The conductivity of the dielectric layer is lower than the conductivity of the first electrode or the second electrode. A voltage of at least 5 volts and preferably a voltage of at least 100 volts is applied between the first electrode and the second electrode. The voltage is applied by means of the first and second conductors. An electronic device for use with the method is also disclosed.

Technical advantages of the methods and devices disclosed include stable electrical characteristics that can be achieved over a large range of operating temperatures. High capacitance and energy density can be achieved because of thinner dielectric layers, since a diffusion barrier is not required.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a top view of a deposition mask in accordance with one embodiment of the present invention.

FIG. 2 is a top view of a substrate during the deposition of electronic devices in accordance with one embodiment of the present invention.

FIG. 3 is a top view of a deposition mask in accordance with one embodiment of the present invention.

FIG. 4 is a top view of a substrate during the deposition of electronic devices in accordance with one embodiment of the present invention.

FIG. 5 is a top view of a substrate during the deposition of electronic devices in accordance with one embodiment of the present invention.

FIG. 6 is a top view of a deposition mask in accordance with one embodiment of the present invention.

FIG. 7 is a top view of a substrate during the deposition of electronic devices in accordance with one embodiment of the present invention.

FIG. 8 is a cross-sectional view of an electronic device in accordance with one embodiment of the present invention.

FIG. 9 is a top view of a substrate supporting several electronic devices in accordance with one embodiment of the present invention.

FIG. 10 is a cross-sectional view of an electronic device configured to store energy in accordance with one embodiment of the present invention.

FIG. 11 is a flow diagram of a method for manufacturing capacitors in accordance with one embodiment of the present invention.

FIG. 12 is a flow diagram of a portion of a method for manufacturing capacitors in accordance with one embodiment of the present invention.

FIG. 13 is a flow diagram of a portion of a method for manufacturing capacitors in accordance with one embodiment of the present invention.

FIG. 14 is a top view of a deposition mask in accordance with one embodiment of the present invention.

FIG. 15 is a top view of a substrate supporting several electronic devices in accordance with one embodiment of the present invention.

FIG. 16 is a graph showing the energy density ratio between BON and PBZT (Y7R).

FIG. 17 is a graph showing thermal-frequency behavior of BON-Ti—based capacitors.

FIG. 18 is a graph showing the thermal behavior of BON-Ti—based capacitors.

FIG. 19 is a flow diagram of a method for storing energy in an electronic device in accordance with one embodiment of the present invention.

### DETAILED DESCRIPTION OF THE DISCLOSURE

FIG. 1 is a top view of a deposition mask in accordance with one embodiment of the present invention. Deposition mask 10 includes body 12 that defines apertures 14 therethrough. Body 12 is formed of a material that blocks deposition when it is placed between the deposition source and the substrate on which the deposition is occurring. Apertures 14 allow particular areas of the substrate to receive deposition. Deposition mask 10 can also be rotated relative to the substrate. Depending upon the characteristics of apertures 14 such a rotation allows for different particular areas of the substrate to receive deposition using the same deposition mask 10. Apertures 14 in deposition mask 10 of FIG. 1 are not radially symmetric and therefore expose different areas of the substrate depending upon the rotation of mask 10. In one embodiment, body 12 of deposition mask 10 is made of a metal and is mechanically placed and rotated between the deposition source and the substrate.

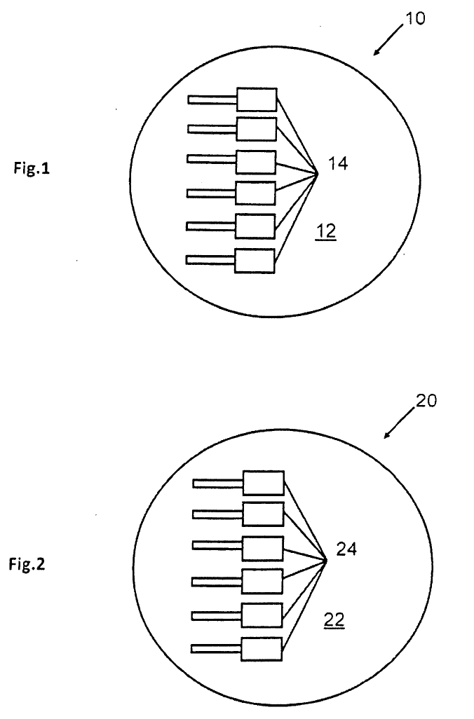

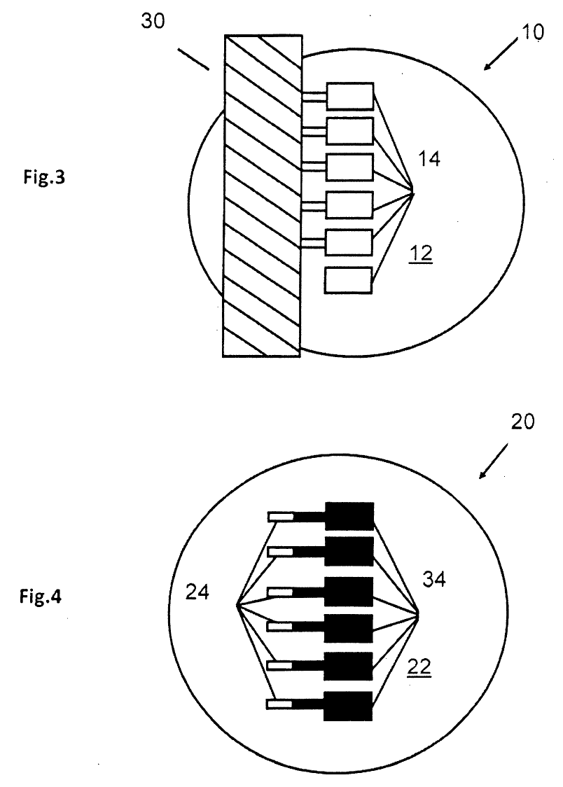

FIG. 2 is a top view of a substrate during the deposition of electronic devices in accordance with one embodiment of the present invention. Substrate 20 in one embodiment is a silicon wafer with surface 22 facing the deposition source. Electrodes 24 are formed by deposition of a conductive material through mask 10 of FIG. 1. In one embodiment the conductive material is titanium and the electrodes have a thickness of approximately 2000 angstroms (Å). Many other conductive materials suitable for electrodes are known to those in the art.

FIG. 3 is a top view of a deposition mask in accordance with one embodiment of the present invention. Portions of apertures 14 in mask body 12 are blocked by shadow bar 30. Shadow bar 30 reduces the areas on which deposition will occur. In another embodiment, shadow bar 30 could be used without deposition mask 10.

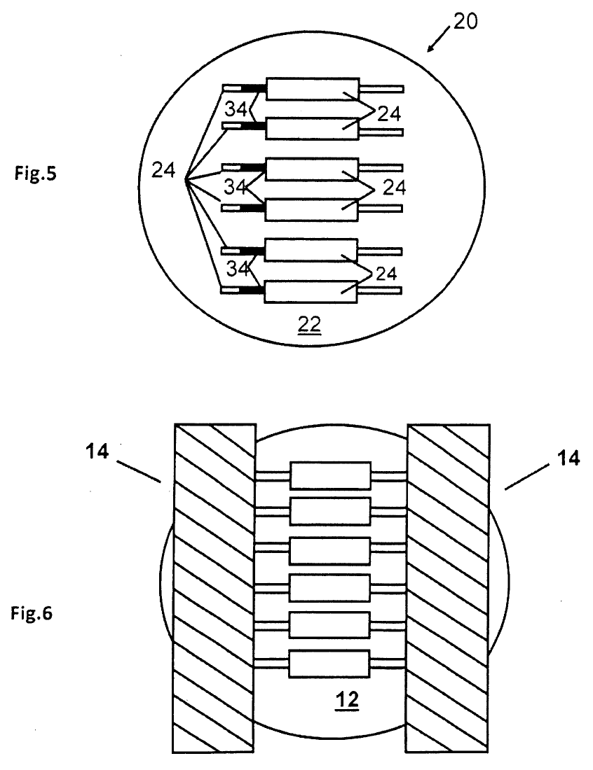

FIG. 4 is a top view of a substrate during the deposition of electronic devices in accordance with one embodiment of the present invention. One portion of electrodes 24 is covered by shadow bar 30 while deposition of dielectric layer 34 occurs, with shadow bar 30 preventing coverage of electrodes 24.

The dielectric layer, deposited next, includes a BNO layer. The BNO layer is formed by physical vapor deposition (PVD) at 350° C. from sources of boron and nitrous oxide. One method of depositing the dielectric layer includes using a boron deposition rate of 0.2 Å/s or less, with particularly advantageous rates being below 0.1 Å/s.

FIG. 5 is a top view of a substrate during the deposition of electronic devices in accordance with one embodiment of the present invention. The partially formed structures of FIG. 4 have been supplemented by the addition of new electrodes 24 deposited using the deposition mask 10 rotated 180° from the position in which the first electrodes 24 were deposited. The overlap of electrodes 24 in the center of each device is separated by dielectric layer 34 previously deposited. The second electrodes for each device can be formed of the same conductive material as the first electrodes or a different conductive material. One example material is Ti, but others are known to those of skill in the art. The second electrodes can be deposited to a thickness of about 300 Å by PVD from a Ti source, for example.

FIG. 6 is a top view of a deposition mask in accordance with one embodiment of the present invention. A first shadow block 30 and a second shadow block 32 reduce the areas on which the deposition will occur. The shadow blocks may not be present in some embodiments.

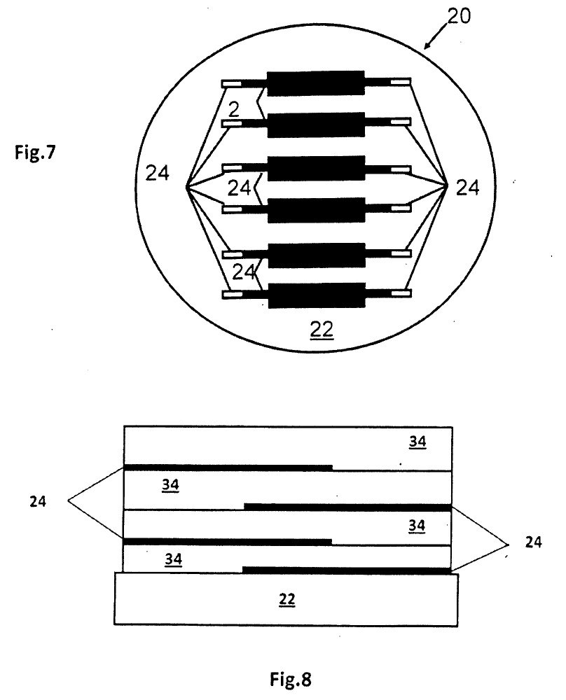

FIG. 7 is a top view of a substrate during the deposition of electronic devices in accordance with one embodiment of the present invention. Dielectric layer 34 is deposited through the apertures in a mask. First and second electrodes 24 are left uncovered. Once the device has reached the state shown in FIG. 7, additional electrodes can be added by varying the orientation of each electrode and including at least a dielectric layer between each electrode layer. In one embodiment, only two electrodes, oriented in opposite directions, are deposited on each device. In another embodiment, many electrodes are deposited, each oppositely oriented from the previous and next, on each device. Deposition mask 10 and devices shown in FIGS. 1-7 allow subsequent electrodes deposited with the same orientation to be in contact. In an alternate embodiment, the dielectric layers can be deposited to cover the entirety of the electrodes.

FIG. 8 is a cross-sectional view of an electronic device in accordance with one embodiment of the present invention. In this device electrodes 24 that extend to each side are not in contact with each other. For example, the dielectric layer that may have completely covered the electrodes or the portions of the device where the electrodes were in contact were cut away. The cross-sectional view shows dielectric layers 34 and each dielectric layer divides oppositely oriented electrodes 24. While only two electrodes of each orientation are shown for ease of illustration, hundreds of layers can be used. In one embodiment, 240 dielectric layers are used to separate the electrodes.

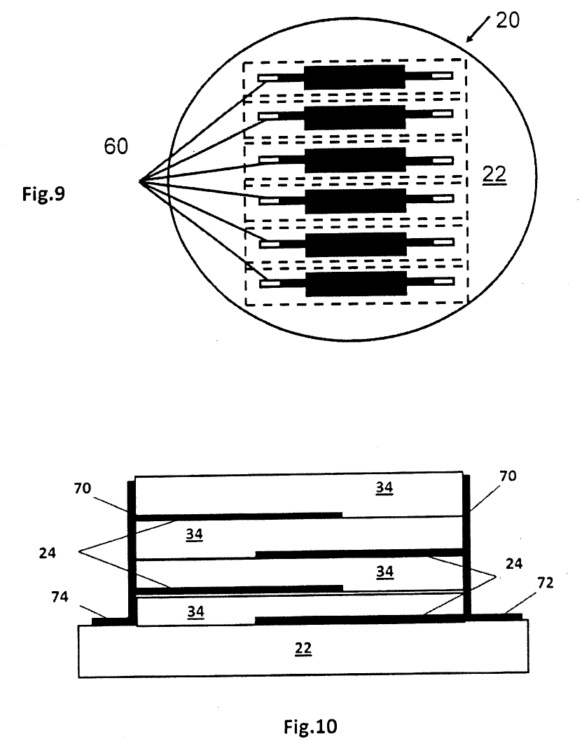

FIG. 9 is a top view of a substrate supporting several electronic devices in accordance with one embodiment of the present invention. Silicon wafer 20 is diced into individual substrates 60. Each individual substrate 60 contains a capacitor. In order to store energy on the capacitor, conductive leads need to be connected to each end of the capacitor.

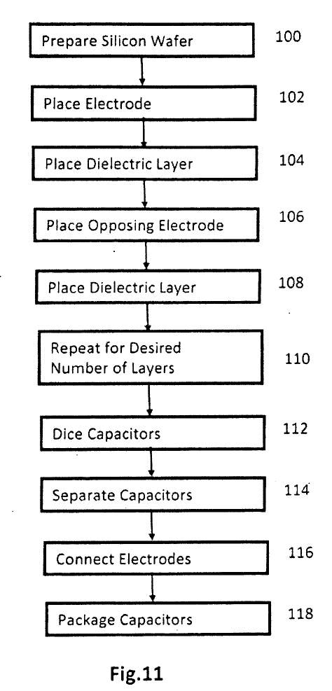

FIG. 10 is a cross-sectional view of an electronic device configured to store energy in accordance with one embodiment of the present invention. The device in FIG. 8 is shown with conductors 70 attached to each of the electrodes 24 extending to one edge of the device. A first lead 72 is conductively coupled to the electrodes 24 that extend to the first side of the device. A second lead 74 is conductively coupled to the electrodes 24 that extend to the second side of the device. The first and second leads 72, 74 are also conductors. A capacitor is a two terminal device with the leads 72, 74 acting as the terminals for connection to an electrical or electronic circuit. In an alternate embodiment, one of the conductors can be connected to a lead placed on the top of the device, above the top dielectric layer 34. The other lead remains on substrate 22. Other placement schemes for the conductive paths to the capacitor terminals are known to those of skill in the art.

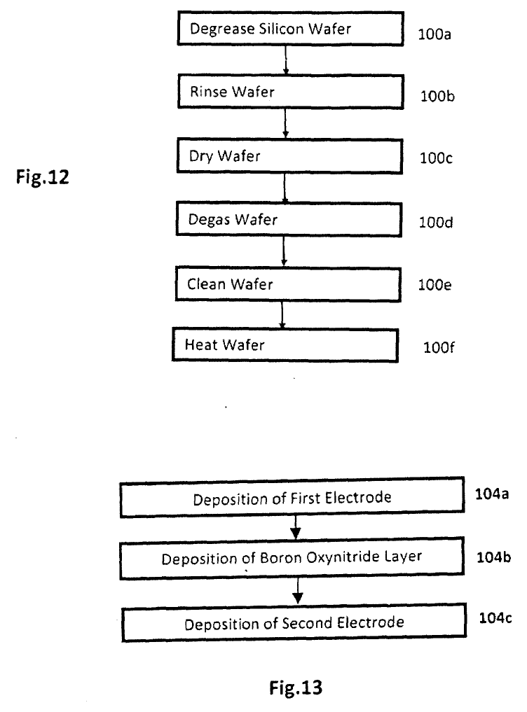

FIG. 11 is a flow diagram of a method for manufacturing capacitors in accordance with one embodiment of the present invention. The first step 100 is preparing a silicon wafer for deposition. The first step 100 is explained in more detail in FIG. 12. The second step 102 is placing an electrode. As described with respect to FIG. 2, PVD and a mask can be used to place conductive material on the silicon wafer to form an electrode. The third step 104 is placing the dielectric layer. The fourth step 106 is placing the opposing electrode. As described with respect to FIG. 5, a rotated mask may be used with PVD to place the electrode. In an alternate embodiment, the second electrode is placed in the same orientation as the first electrode, but the first and second electrodes are not conductively coupled.

Fifth step 108 repeats third step 104. Sixth step 110 comprises additional series of steps 102 through 108 for the number of layers desired. Seventh step 112 is dicing the wafer into separate substrates, each containing one capacitor. Eighth step 114 is separating the diced separate substrates from each other. In an alternate embodiment, seventh step 112 and eighth step 114 are unnecessary, because only one capacitor has been placed on the wafer. Ninth step 116, which is performed on the individual capacitors, is connecting the electrodes to two conductors. The final step 118 is packaging the capacitors, using technology well known in industry.

FIG. 12 is a flow diagram of a portion of a method for manufacturing capacitors in accordance with one embodiment of the present invention. The step of preparing the wafer 100, shown in FIG. 11, itself comprises several steps. The first step 100a is degreasing the silicon wafer. Conventional solvents are used in the degreasing step 100a. The second step 100b is rinsing the wafer. In on embodiment, the wafer is rinsed in de-ionized water for consistent electrical characteristics. The third step 100c is drying the wafer. In one embodiment the wafer is dried with nitrogen gas N₂. The fourth step 100d is degassing the wafer. In one embodiment, the wafer is degassed in the deposition chamber at 850° C. for 15 minutes at a pressure of 10⁻⁸ torr. The fifth step 100e is cleaning the wafer. One method of cleaning the wafer is to bombard the wafer with argon for 10 minutes. The final preparatory step 100f is heating the wafer to the temperature at which deposition will occur. The temperature can vary and in one embodiment is in the range of 80-600° C.

FIG. 13 is a flow diagram of a portion of a method for manufacturing capacitors in accordance with one embodiment of the present invention. The step of placing the dielectric 104 and 108, shown in FIG. 11, itself comprises several steps. First step 104a is deposition of a first electrode. Second step 104b is deposition of a boron oxynitride layer. Third step 104c is deposition of a second electrode.

FIG. 14 is a top view of a deposition mask in accordance with one embodiment of the present invention. In order to store sufficient energy, the capacitors preferably have an area of at least 100 μm². On an 8-inch silicon wafer, thousands of capacitors can be produced at once. Another embodiment of the invention involves using mask 80 with a large number of apertures 82 to guide deposition of capacitor layers. For ease of illustration, FIG. 14 does not illustrate the actual number of apertures needed for capacitors having dimensions on the order of a millimeter being grown on a wafer having a diameter on the order of ten inches. Mask 80 is not used in conjunction with shade blocks such as those shown in FIGS. 3 and 6. Instead, the dielectric layer is grown over the entire surface of the wafer. Only the electrodes are deposited through the mask 80.

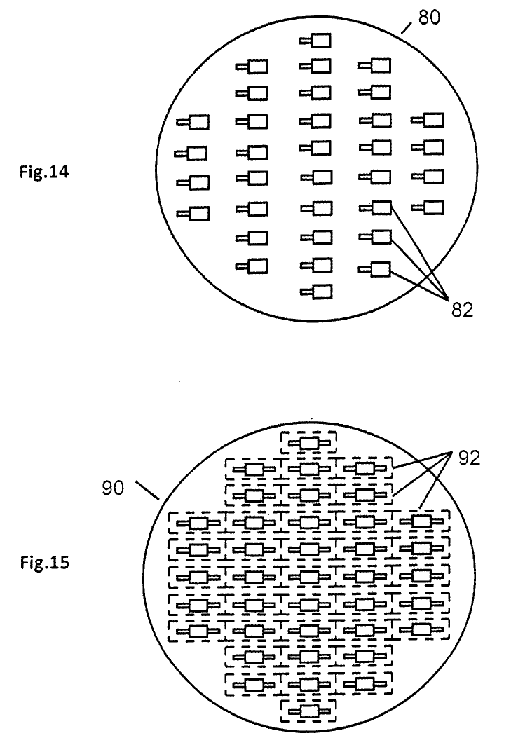

FIG. 15 is a top view of a substrate supporting several electronic devices in accordance with one embodiment of the present invention. FIG. 15 shows silicon wafer 90 bearing capacitors 92 that result from depositing electrodes using mask 80 and depositing the dielectric layer over the entire surface of the wafer. As with FIGS. 1-7, repeated sets of opposing electrodes with intervening layers can be grown to increase the capacitance. The dotted lines show the dicing of the individual substrates.

Estimation of the dielectric constant (K) of the BNO layers from experimental measurement of the capacitor in the Ti//BNO/Ti structure gives a value of ˜4.0. This dielectric constant value is within the range of the values assigned to h-BN and boron oxide compounds. The dielectric constant (K) has been estimated from the above equation by taking as inputs:

C=1.20 nF@ 10 KHz

d=3500 Å

A=3×4 mm²

f=11.31 (centimeter)

Based on the capacitance measurement, one can estimate the value for multilayer capacitors and compare it with values for multilayer capacitors based on sintering technology.

An example of a capacitor based on sintering technology is described in J. Harada et al, “Y7R-designated 6.8° F. multilayer ceramic capacitors in EIA 1206 size,” Electronic Manufacturing Technology Symposium, Japan, 1995, p. 323. With this capacitor, based on Y7R-designated 6.8 μF MLCCs@1 KHz with 240 dielectric layers 3.2 μm thick each, devices were successfully fabricated in EIA 1206 size (3.2 mm×1.6 mm×1.5 mm) using a relaxor dielectric ceramic (PBZT).

Using the same electrode area (3.2 mm×1.6 mm) and about the same layer counts (241), the calculated capacitance for different values of BON thickness and the energy density ratio are compared to sintering capacitors in Table 1, using Eq. 1 and Eq.2, cited above. According to the equation of capacitors:

C₁(μF)=434×1/d d (Angstrom): BON thickness layer

The energy density stored in a capacitor is the energy/volume
The energy density ratio calculated at the same rating voltage is:

$$δ = \frac{{C}_{1} / {VL}_{1}}{{C}_{2} / {VL}_{2}} = \frac{{C}_{1}}{{C}_{2}} \times \frac{{VL}_{2}}{{VL}_{1}} \qquad Eq . 3$$

C₁, VL₁: capacitance and volume of a BON dielectric layer
C₂, VL₂: capacitance and volume of a Y7R-PBZT dielectric layer
C₂=6.8 μF, V₂=3.2 mm×1.6 mm×1.5 mm; V₁=3.2 mm×1.6 mm×(d₁+d₂)
d₁: BON layers total thickness
d₂: Total thickness of the metal electrode layers

TABLE I
Comparisons of Energy Density Ratio
of BON and Sintering Capacitors

| BON dielectric | Total BON dielectric | Capacitance | Energy density | |
|---|---|---|---|---|
| Thickness | Thickness (d₁) | (C₁) | ratio* δ | |
| (Å) | (μm) | (μF) | I | II |
| 100 | 2.4 | 4.34 | 36.1 | 132.5 |
| 200 | 4.8 | 2.17 | 16.5 | 49.7 |
| 300 | 7.2 | 1.44 | 10.1 | 26.4 |
| 400 | 9.6 | 1.08 | 7.0 | 16.5 |
| 500 | 12 | 0.87 | 5.3 | 11.4 |
| 600 | 14.4 | 0.72 | 4.1 | 8.2 |
| 700 | 16.8 | 0.62 | 3.3 | 6.3 |
| 800 | 19.2 | 0.54 | 2.7 | 4.9 |
| 900 | 21.6 | 0.48 | 2.3 | 4.0 |
| 1000 | 24.0 | 0.43 | 2.0 | 3.3 |

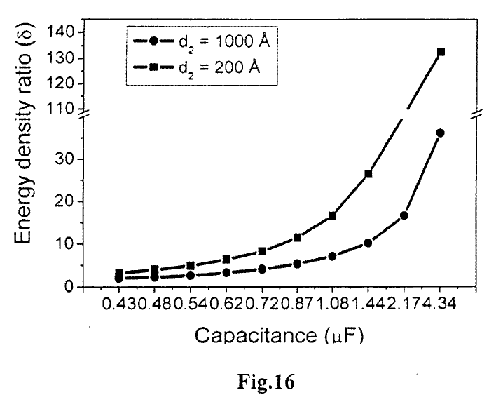

At the same rating voltage, the calculated ratios of the energy density for a BON-based capacitor and a PBZT (Y7R) capacitor for various values of capacitance are also shown in FIG. 16. The two curves represent ratios for the two values of total thickness of metal electrode layers shown below.

d₂=1000 Å×241 layers=24.1 μm I

d₂=200 Å×241 layers=4.82 μm II

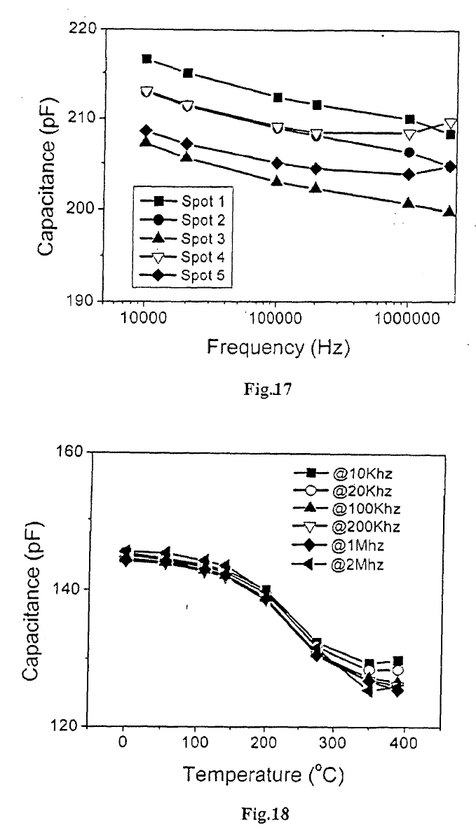

Capacitor devices were demonstrated by making and testing Ti/BON/Ti/Si capacitor structures. The measured capacitance values at 10 KHz were about 0.2 nF for 200 nm thick BON layer and an area of 1 mm² for the 200 nm thick Ti electrode. Results indicate a very small variation (˜3%) of capacitance over a range of frequencies 10 KHz-2 MHz (FIG. 17) and about 13% variation in capacitance over a range of temperatures 25° C.-400° C. at frequencies from 10 khz to 2 Mhz. (FIG. 18). In contrast, a dielectric that allows diffusion of the electrode material into or through the dielectric shows a significant decrease in capacitance over the temperature range cited.

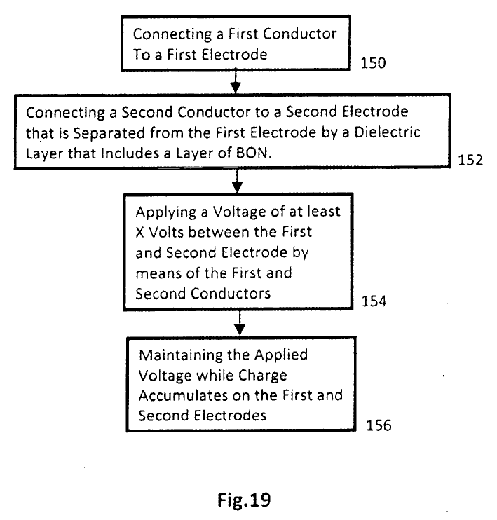

FIG. 19 is a flow diagram of a method for storing energy in an electronic device in accordance with one embodiment of the present invention. First step 150 is connecting a first conductor to a first electrode of the device. Second step 152 is connecting a second conductor to a second electrode that is separated from the first electrode by a BNO dielectric layer. Third step 154 is applying a voltage of at least about 5 volts between the first and second electrodes by means of the first and second conductors. In response to maintaining the voltage 156, charge accumulates on the first and second electrodes. A voltage of about 5 volts is necessary to store a useful amount of energy in the device.

Although the present disclosure has been described in detail, it should be understood that various changes, substitutions and alterations can be made thereto without departing from the spirit and scope of the invention as defined by the appended claims.

I claim:

1. An electronic device, comprising:
a pair of electrically connected electrodes consisting of a first and a second electrode; and
a layer of boron oxynitride disposed between the first electrode and the second electrode, wherein the first and second electrodes are formed of material with greater conductivity than the boron oxynitride layer.

2. The device of claim 1 further comprising:
a plurality of pairs of electrodes, each pair being separated by a layer of boron oxynitride.

3. The device of claim 1 wherein the electrodes are made of titanium.

4. An electronic device, comprising:
a first electrode; and
a first dielectric layer positioned between the first electrode and the second electrode, the first dielectric layer comprising a layer of boron oxynitride, wherein the first electrode is formed of a material with greater conductivity than the first dielectric layer, the second electrode is formed of a material with greater conductivity than the first dielectric layer, and the area of the first dielectric layer is greater than 1 μm².

5. The device of claim 4, further comprising:
a third electrode conductively coupled to the first electrode;
a second dielectric layer positioned between the third electrode and a second electrode, the second dielectric layer comprising a layer of boron oxynitride;
a fourth electrode conductively coupled to the second electrode; and
a third dielectric layer positioned between the fourth electrode and the third electrode, the third dielectric layer comprising boron oxynitride.

6. A method for storing energy in an electronic device, comprising:
connecting a first conductor to a first electrode of a single capacitor;
connecting a second conductor to a second electrode of the capacitor, the second electrode being separated from the first electrode by at least a dielectric layer comprising a layer of boron oxynitride, the dielectric layer having a lower a lower conductivity than the first electrode or the second electrode; and
applying a voltage of at least 5 volts between the first electrode and the second electrode by means of the first and second conductors.

7. The method of claim 6, further comprising:
maintaining the applied voltage while charge accumulates on the first and second electrodes.

8. The method of claim 7 wherein the area of the dielectric layer is greater than 1 μm².

9. A method for forming a capacitor comprising:
providing a substrate;
depositing a first electrode on the substrate in a selected configuration;
depositing a first boron oxynitride dielectric layer on a least a portion of the first electrode; and
depositing a second opposing electrode in a selected configuration on the first boron oxynitride dielectric layer.
